(19) United States
(12) Patent Application Publication
(10) Pub. No.: US 2012/0116669 A1
(43) Pub. Date: May 10, 2012

(54) TRAVELLING ROUTE GUIDANCE SYSTEM AND CAR-AUDIO APPARATUS AND METHOD OF GUIDING ROUTE USING THE SAME

(75) Inventors: Bum Tae Lee, Goyang (KR); Heung In Park, Yongin (KR); Chi Nam Oh, Suwon (KR); Min Suk Kim, Yongin (KR); Young Eon Ma, Ulsan (KR)

(73) Assignees: KIA MOTORS CORPORATION, Seoul (KR); HYUNDAI MOTOR COMPANY, Seoul (KR)

(21) Appl. No.: 13/041,726

(22) Filed: Mar. 7, 2011

(30) Foreign Application Priority Data
Nov. 9, 2010 (KR) 10-2010-0111056

(51) Int. Cl. G01C 21/36

(52) U.S. Cl. 701/419; 701/431

(57) ABSTRACT

A route guidance system, a car-audio apparatus thereof, and a method for providing route guidance using the same are provided. The route guidance system using a car-audio apparatus which includes an input module for receiving destination information to be visited by a driver from the driver via, e.g. a voice command, a location tracking module which determines a present location information of a vehicle, and a control module which transfers voice information for the present location information of the vehicle and the destination information to the server. Route guidance information, received from the server, is searched via an electronic map on the server. The control module transfers the route guidance information to the car-audio apparatus and allows the car-audio apparatus to display the route information through an interface of a display module of the car-audio apparatus.

### CROSS-REFERENCES TO RELATED APPLICATIONS

Priority is claimed to Korean patent application number 10-2010-111056, filed on Nov. 9, 2010, the entire contents of which application is incorporated herein for all purposes by this reference.

### BACKGROUND OF THE INVENTION

1. Field of the Invention

The present invention relates to a system which guides a driver along a route between a starting location and destination location requested by a user using an audio apparatus of a vehicle, the car-audio apparatus, and a method of guiding the travelling route using the same.

2. Description of the Related Art

Conventional navigation systems typically include an electronic map database, a path searching module, a display module and the like. The electronic map database contains various kinds of route guidance information, destination information, and the like to be constructed on an electronic map. The path searching module input information for a starting location and a destination location from a driver and search a travelling route between the starting location and the destination location based on the electronic map database. The display module displays the travelling route transferred from the path searching module on a screen. Since the electronic map database, the path searching module and the display module should be included in one terminal of the navigation system, there is a resulting a high fabrication cost. In addition, one noted disadvantage of the conventional systems is that the driver needs to periodically upgrade the electronic map database in the navigation system in order for all of the information to remain update. For example, towns and states are constantly building new roads and neighbourhoods which may not be on older versions of the electronic map database.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

The present invention provides a travelling route guidance system for use in a car-audio apparatus which receives a request for route guidance between a starting location and a destination location from a user through a voice command spoken by the user. The request is then transferred to the server, and in response the car-audio apparatus receives travelling route information between the present location of a vehicle and the destination location. In calculating the route an electronic map on the server is searched at the server and the resulting route information is transmitted back to the car audio apparatus. The route information is then displayed to the user through an interface of a display module in a car-audio apparatus, the car-audio apparatus, and a method of guiding a route using the same.

According to an aspect of the present invention, a travelling route guidance system implemented in a car-audio apparatus includes an input module which receives destination information to be visited by a driver from the driver through a voice command spoken by the driver, a location tracking module which determines the present location information of a vehicle, and a control module which transfers voice command information for the present location information of the vehicle and the destination information to the server. The control module then receives travelling route information (route guidance information) for between the present location of the vehicle and the destination location input by the user. As noted above the route guidance information is determined by searching through the electronic map database on the server. Furthermore, the control module transfers the route information to the car-audio apparatus and allows the car-audio apparatus to display the route information through an interface of a display module of the car-audio apparatus.

The route guidance information may include a left-turn guidance at a specific intersection, a right-turn guidance at the specific intersection, a straight guidance, a straight distance guidance, road information associated with the roads being traveled in the route guidance information and destination arrival information. The left-turn guidance at the specific intersection, the right-turn guidance at the specific intersection and the straight distance may be displayed through a rewinding interface, a forward winding interface, and a reproducing interface of the display module of the car-audio apparatus, respectively. The road information and the destination arrival information may be displayed through a reproducing music information interface or a radio channel information display interface of the display module of the car-audio apparatus, respectively.

The input module may be configured to only receive the destination information to be visited by the driver from the driver through a voice command spoken by the user if the input module inputs a start button of the car-audio apparatus through the car-audio apparatus by a driver. That is, the driver is this embodiment of the present invention must first press a button on the interface of the car-audio apparatus before the system can receive destination information to be spoken by the driver in the form of a voice command.

The control module may further include a data processing module which transfers interface information of a display module of the car-audio apparatus from the car-audio apparatus, and processes the route guidance information between the present location information of the vehicle and the destination location information to be compatible with the car-audio apparatus which uses the interface information, and transfers the processed route guidance information to the car-audio apparatus.

According to another aspect of the present invention, a car-audio apparatus having a route guidance system includes a start button which receives a starting signal for initiating a request for a route between a present location of a vehicle and a destination location by a driver and transfers the starting signal to the travelling route guidance system. In this embodiment of the present invention, a mode change module changes a mode of the car-audio apparatus from an audio reproducing mode or a radio reproducing mode to a travelling route providing mode according to the starting signal. A data processing module receives route guidance information, which is searched through an electronic map by a server, between present location information of the vehicle and the destination location which may input by a driver through a voice command spoken by the driver or user, and processes the route information to be suitable to an interface of the car-audio apparatus. A display module then displays the route guidance information.

In some embodiments of the present invention, the route guidance information may include a left-turn guidance at a specific intersection, a right-turn guidance at the specific intersection, a straight guidance, a straight distance guidance, road information related to the route being travelled and destination arrival information. The data processing module may display the left-turn guidance at the specific intersection, the right-turn guidance at the specific intersection and the straight distance guidance using a rewinding display interface, a forward winding display interface, and a reproducing display interface of the display module of the car-audio apparatus, respectively. The data processing module may display the road information, the straight distance guidance and the destination arrival information using a reproducing music information display interface or a radio channel information display interface of the display module of the car-audio apparatus.

According to another aspect of the present invention, a method of guiding a travelling route using a car-audio apparatus includes (a) receiving destination information to be visited by a driver through a voice command spoken by the driver, (b) determining present location information of a vehicle, (c) transferring voice command information for the present location information of the vehicle and the destination information to a server and receiving route guidance information for between the present location of the vehicle and the destination, which is searched through an electronic map of the server, from the server, and (d) transferring the route information to the car-audio apparatus and displaying route information through an interface of a display module of the car-audio apparatus.

The route guidance information may include a left-turn guidance at a specific intersection, a right-turn guidance at the specific intersection, a straight guidance, a straight distance guidance, road information associated with the route to be traveled and destination arrival information. In displaying the route guidance information, the left-turn guidance at the specific intersection, the right-turn guidance at the specific intersection and the straight distance guidance may be displayed through a rewinding interface, a forward rewinding interface, and a reproducing interface of the display module of the car-audio apparatus, respectively, and the road information and the destination arrival information may be displayed through a reproducing music information interface or a radio channel information display interface of the display module of the car-audio apparatus, respectively.

In some embodiments of the present invention, the method may further includes receiving the destination information to be visited by the driver through via a voice command in response to an engaged button of the car-audio apparatus being input through the car-audio apparatus by the driver, before receiving the destination information to be visited by the driver. That is, the driver is this embodiment of the present invention must first press a button on the interface of the car-audio apparatus before the system can receive destination information to be spoken by the driver in the form of a voice command.

According to another aspect of the present invention, a method of guiding a travelling route using a car-audio apparatus may also include (a) receiving a starting signal for starting to request a route between a present location of a vehicle and a destination location from a driver and transferring the starting signal to a travelling route guidance system according to the starting signal being received, (b) changing a mode of the car-audio apparatus from an audio reproducing mode or a radio reproducing mode to a route providing mode, (c) receiving, from the route guidance system in the route providing mode, route information, which is searched through an electronic map by a server, between present location information of the vehicle and the destination location which are input by a driver through a voice command, and processing the route guidance information to be suitable to an interface of the car-audio apparatus, and (d) displaying the route guidance information in response to processing the information accordingly.

The route guidance information also may include a left-turn guidance at a specific intersection, a right-turn guidance at the specific intersection, a straight guidance, a straight distance guidance, road information and destination arrival information. In displaying the route guidance information, the left-turn guidance at the specific intersection, the right-turn guidance at the specific intersection and the straight guidance may be displayed through a rewinding interface, a forward winding interface, and a reproducing interface of the display module of the car-audio apparatus, respectively, and the road information associated with the route being traveled, the destination arrival information, and the straight distance guidance may be displayed through a reproducing music information interface or a radio channel information display of the interface of a display module of the car-audio apparatus.

Advantageously, the travelling route guidance system may display the route guidance information using the interface of the car-audio apparatus without using an on board navigation system which conventionally would include separate electronic map database, path searching module, display module. Therefore, the driver may conveniently receive the route guidance information to the destination only using the travelling route guidance system having a mobile communication terminal and the car-audio apparatus without having a high-priced navigation system. In addition, the route guidance system allows the driver to conveniently request the travelling route to the destination through via a voice command.

Furthermore, because the electronic map database is located on a server rather then in the vehicle itself. There is no need to continually update the electronic map database like in the conventional navigation systems discussed above.

The methods, terminals and systems of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of an exemplary travelling route guidance network according to the present invention.

FIG. 2 is a block diagram illustrating a configuration of an exemplary travelling route guidance system according to the present invention.

FIG. 3 is a block diagram illustrating a configuration of an exemplary server according to the present invention.

FIG. 4 is a block diagram illustrating a configuration of an exemplary car-audio apparatus according to the present invention.

FIGS. 5 to 9 are configuration diagrams illustrating figures displaying route guidance information using an interface of a car-audio apparatus via a display module of the car-audio apparatus according to an exemplary embodiment of the present invention.

FIG. 10 is a flow chart illustrating a sequence of a method of guiding a travelling route using an exemplary travelling route guidance network according to an exemplary embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

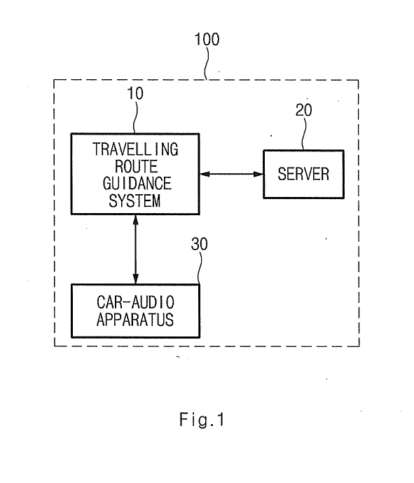

FIG. 1 is a block diagram illustrating an exemplary configuration of a travelling route guidance network 100 according to the present invention.

As shown in FIG. 1, the travelling route guidance network 100 according to the present invention includes a travelling route guidance system 10, a server 20, a car-audio apparatus 30, and the like.

The travelling route guidance system 10 may be disposed in a mobile communication terminal and configured to input destination information to be visited by a driver through via a command, e.g., a voice command by the driver or user and transfer the destination information to the server 20. Upon receiving route guidance information from the server, the travelling route guidance system 10 transfers route guidance information to the car-audio apparatus and allows the car-audio apparatus 30 to display the route guidance information through an interface of a display module 35 of the car-audio apparatus 30.

The server 20 may include a voice recognition module which identifies words spoken by the user/driver. In this case, the words spoken by the user or driver correlates directly to the present location information of a vehicle and the destination location information. This information is then utilized by a database 21 on the server where an electronic map is constructed. The server 20 searches route information within the data base for determined present location information of the vehicle and the voice recognized destination information using the electronic map database 21 and transfers the searched route information to the travelling route guidance system 10.

The car-audio apparatus 30 in the illustrative embodiment of the present invention is installed in a vehicle and can selectively change a mode thereof from an audio reproducing mode or a radio reproducing mode to a travelling route providing mode and transfer a starting signal to the travelling route guidance system 10 if the car-audio apparatus 30 inputs the starting signal for starting to request the route between the present location of the vehicle and the destination location information input by the driver. The car-audio apparatus 30 receives the route guidance information between the present location of the vehicle and the destination location from the travelling route guidance system 10 once the mode has been changed to route providing.

Components of the route guidance network 100 according to the present invention are described in further detail below.

### Configuration of the Travelling Route Guidance System

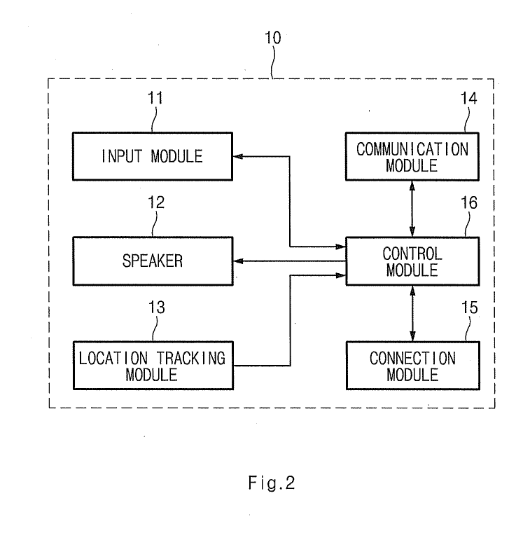

FIG. 2 is a block diagram illustrating a configuration of the travelling route guidance system 10 according to the present invention.

As illustrated in FIG. 2, the travelling route guidance system 10 may be embedded with a mobile communication terminal and includes an input module 11, a speaker 12, a location tracking module 13, a connection module 15, a control module 16, and the like.

The input module 11 may be embedded with a microphone and receives the destination information to be visited by the driver under the control of the control module 16 described later. The destination information may be input by the driver via e.g., a voice command spoken by the driver. The input module 11 may be included in the travelling route guidance system 10 or in the car-audio apparatus 30 described later instead of the travelling route guidance system 10.

The speaker 12 outputs a guidance message for requesting to input the destination information to be visited to the driver under the control of the control module 16.

The location tracking module 13 may be embedded with a global positioning system (GPS) receiver, or the like that is capable of determining or locating the present location of the vehicle.

The communication module 14 may be embedded with a telecommunication module such as a code division multiple access (CDMA) and data communicates with the server 20 under the control of the module 16.

The connection module 15 may be embedded with a wireless communication module and is connected to the car-audio apparatus 30 described later by configuring as car-audio apparatus 30.

The control module 16 outputs the guidance message for requesting an input of the designation information via a voice command spoken by the driver or user from the car-audio apparatus 30 to the driver via the speaker 12 if the car-audio apparatus 30 receives the starting signal input through the start button 32 (a start button engaged for initiating a request to route between the destination and the present location of the vehicle) from the driver. The control module 16 receives the destination information to be visited by the driver from the driver through the input module 11 in a voice format. The control module 16c determines the present location information of the vehicle using the location tracking module 13. The control module 16 then transfers the information for the present location information of the vehicle and the voice information for the destination information to the server 20. Upon receiving the route guidance information for between the present location of the vehicle and destination, the control module 16 transfers the route guidance information to the car-audio apparatus 30. That is, the route guidance information is computed by searching through an electronic map of the server 20.

The route information of any embodiment may include a left-turn guidance at a specific intersection, a right-turn guidance at the specific intersection, a straight guidance, a straight distance guidance, road information associated with the route to be traveled and destination arrival information. Accordingly, the route information is for guiding the travelling route with turn by turn scheme which informs the driver when the vehicle changes its direction and where the vehicle changes its direction. Notably, the control module 16 does not transfer the entire route guidance information to the car-audio apparatus 30. Rather, the control module 16 selectively extracts the route information corresponding to the present location of the vehicle determined via the location tracking module 13 and where the location tracking module 13 is not included in the car-audio apparatus 30, transfers the extracted route information to the car-audio apparatus 30.

As another embodiment, if the location tracking module 13 is included in the car-audio apparatus 30, the control module 16 may transfer the entire route guidance information to the car-audio apparatus 30. For example, the route guidance information could be information relating a traffic situation, an up-to-date traffic condition or other traffic information. Additionally, the route information may be shown in red color, yellow color and green color, when distance from the present location to the destination is less than, for example, 20 miles, 40 miles and 60 miles, respectively.

### Configuration of the Server

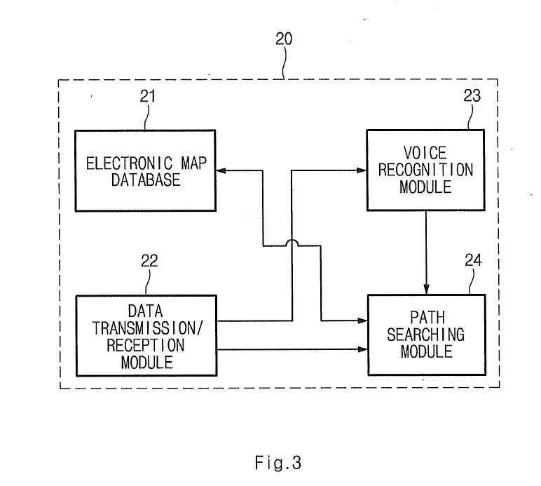

FIG. 3 is a block diagram illustrating a configuration of the server 20 according to the present invention.

As shown in FIG. 3, the server 20 includes an electronic map database 21, a data transmission/reception module 22, a voice recognition module 23, a path searching module 24, and the like.

The electronic map database 21, as illustrated, stored an electronic map on which various kinds of guidance information, destination information, or the like 5 are constructed.

The data transmission/reception module 22 communicates with the route guidance system 10 for sending and receiving data.

The voice recognition module 23 receives voice information spoken by the user relating to the destination information received from the travelling route guidance system 10. Operatively, the voice recognition module voice-recognizes the received voice information, and transfers the voice-recognized destination information to the path searching module 24 along with the present location of the vehicle which was determined by the control unit 16.

The path searching module 24 generates route information for the present location information of the vehicle and the destination based on the electronic map stored in the electronic map database 21 and transfers generated route guidance information for the present location of the vehicle and the destination location to the travelling route guidance system 10.

### Configuration of the Car-Audio Apparatus

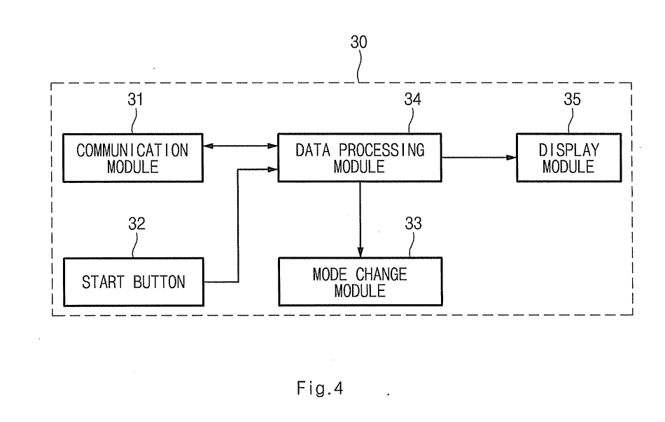

FIG. 4 is a block diagram illustrating a configuration of the car-audio apparatus 30 according to the present invention

As shown in FIG. 4, the car-audio apparatus 30 includes a communication module 31, the start button 32, a mode change module 33, a data processing module 34, a display module, and the like.

The communication module 31 may be embedded with a wired or wireless communication module and configured as a conventional pairing relationship with the connection module 15 of the travelling route guidance system 10 to allow for data communication with the travelling route guidance system 10.

The start button 32 initiates a starting signal for initiating a request to start routing between the present location of the vehicle and the one or more destinations inputted by the driver/user. Upon engaging the start button the starting signal is sent to the mode change module 33 and the travelling route guidance system 10. Additional, if the start button 32 is input again by the driver, a termination signal may be generated and sent to the mode change module 33 and the traveling route guidance system 10.

The mode change module 33 may change a mode of the car-audio apparatus 30 from an audio reproducing mode or a radio reproducing mode to a route providing mode if mode change module 33 receives the starting signal from the start button 32.

The data processing module 34 receives the route guidance information between the present location and the destination location or locations from the location guidance system 10 while the car-audio apparatus 30 is in the route providing mode. As described above, the data processing module 34 receives all data for the route guidance information between the present location and the destination location from the travelling route guidance system 10 when the location tracking module 13 is included in the car-audio apparatus 30.

Alternatively, the data processing module 34 may periodically receive a portion of the route guidance information corresponding to the present location of the vehicle from the route guidance system 10 when the path searching module 13 is not included in the car-audio apparatus 30. The data processing module 34 may also output guidance comments included in the route information through the separate speaker 12.

As mentioned above, the data processing module 34 may be included in the travelling route guidance system 10 instead of the car-audio apparatus 30. In this case, the travelling route guidance system 10 may receive interface information of the display module 35 of the car-audio apparatus 30 from the car-audio apparatus 30 when the travelling route guidance system 10 performs a pairing procedure with the car-audio apparatus 30. The travelling route guidance system 10 may then process the route guidance information to be compatible with an interface of the display module 35 of the car-audio apparatus 30 using the interface information in advance, and transfer the processed route guidance information to the car-audio apparatus 30, accordingly. At this time, the travelling route guidance system 10 may provide general-purpose route guidance information if the route guidance system 10 is configured as pairing relationship with the car-audio apparatus 30 having any specification.

The car-audio apparatus 30 may have a unique interface when it is in an audio (compact disc (CD), MP3 file, etc.) reproducing mode or a radio reproducing mode. That is, the car-audio apparatus 30 may have a rewinding interface, a reproducing interface, a forward winding interface, a reproducing music information display interface, a radio channel information display interface, and the like. The data processing module 34 processes the route guidance information to be compatible with a display command signal and transfers the processed route information to the display module 35 so that the display module 35 may display, e.g., a left-turn guidance at the specific intersection, a right-turn guidance at the specific intersection and/or a straight guidance, using a rewinding display interface (e.g., commanding a move to previous song), a forward winding display interface (e.g., commanding a move to next song), and a reproducing display interface of the display module of the car-audio apparatus, respectively and the road information relating to the route being traveled, a straight distance guidance, and the destination arrival information using a reproducing music information display interface or a radio channel information display interface of the car-audio apparatus 30.

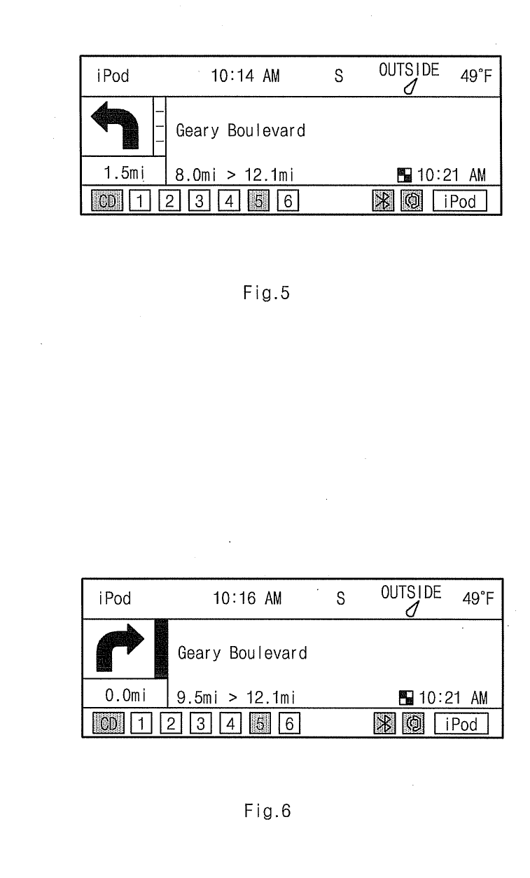

FIGS. 5 to 9 are configuration diagrams illustrating figures illustrating the display module 35 of the car-audio apparatus 30 displaying route information using an interface of the car-audio apparatus 30 according to the present invention.

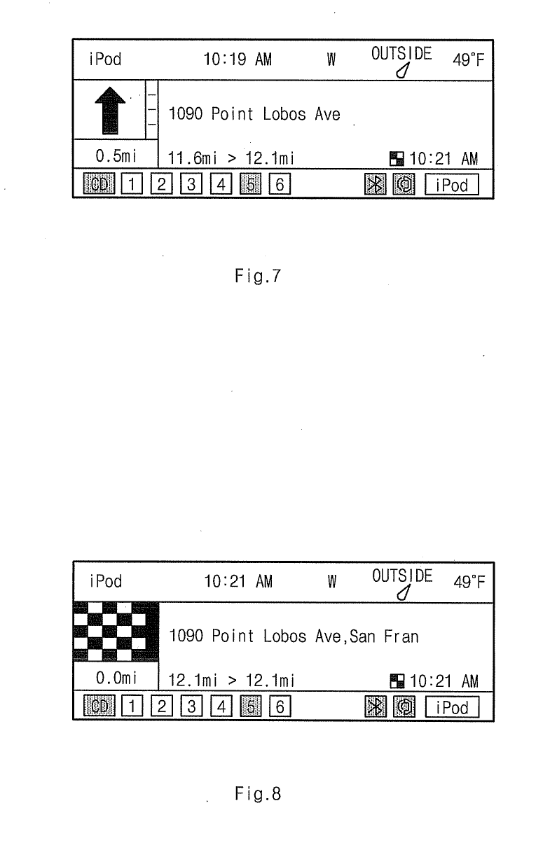

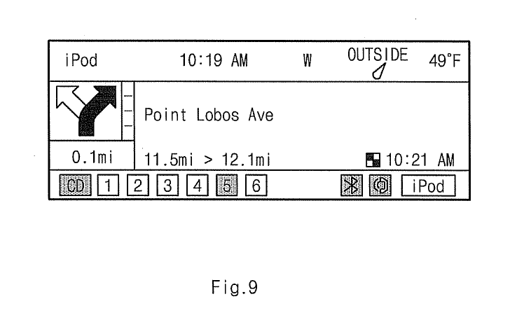

The display module 35 may be embedded as a liquid crystal display (LCD), a light emitting display (LED), or the like and displays the route guidance information processed to be compatible with the interface of the car-audio apparatus 30 transferred from the data processing module 34 using an interface of the car-audio apparatus 30. That is, the display module 35 may display, e.g. the left-turn guidance at a specific intersection using the rewinding interface (referring to FIG. 5) and the right-turn guidance at the specific intersection using the forward winding interface (referring to FIG. 6). The display module 35 may display the straight guidance using the reproducing display interface (referring to FIG. 7). Additionally, the display module 35 may display the road information, the straight distance guidance and the destination arrival information using the reproducing music information display interface or a radio channel information display interface of the car-audio apparatus 30, respectively (referring to FIG. 8). Here, the route information may further include information additional information, for example, an estimated time of arrival, remaining distance information to the destination, guidance information of various buildings, traffic condition information, present speed of a vehicle, a GPS signal strength, or the like. In addition, the display module 35 may highlight only an arrow of the corresponding direction via mixing the forward winding interface, a reverse winding interface, and the like, when coming to the fork of a road (referring to FIG. 9).

A method of guiding a route using the route guidance network 100 according to the present invention is described below.

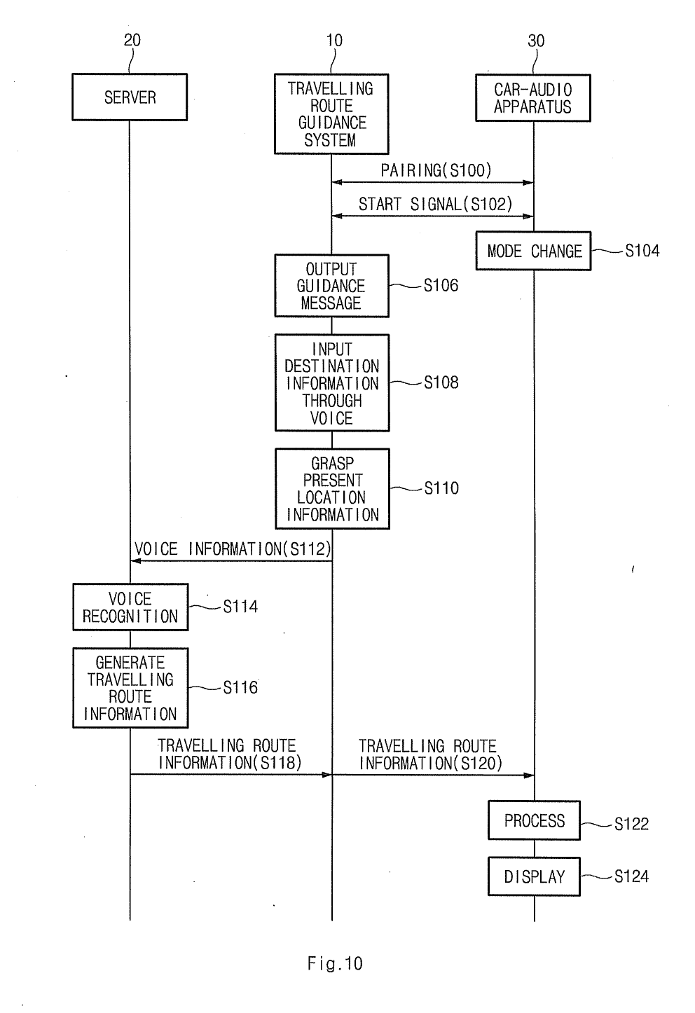

FIG. 10 is a flowchart illustrating an exemplary sequence of a method of guiding a driver along a route using the route guidance network 100 according to the exemplary embodiment of the present invention.

Initially, the car-audio apparatus 30 and the travelling route guidance system 10 are connected/paired to construct a mutual pairing relationship (S100).

The data processing module 34 of the car-audio apparatus 30 then inputs a starting signal for starting to request a route between a present location of a vehicle and a destination location inputted by a driver by pressing the start button 32 and transferring the starting signal to the mode change module 33 and the travelling route guidance system 10 (S102). The mode change module 33 of the car-audio apparatus 30 changes a mode of the car-audio apparatus 30 from an audio reproducing mode or a radio reproducing mode to a route providing mode (S104).

Next, the control module 16 of the travelling route guidance system 10 outputs a guidance message for requesting an input destination location using the speaker 12 which is received from the driver via a command, e.g. a voice command spoken by the driver into an input module on the travelling route guidance system (S106).

The control module 16 of the travelling route guidance system 10 receives the destination information to be visited by the driver using the input module 11 via the user or drivers voice (S108).

The control module 16 of the travelling route guidance system 10 then grasps/determines the present location information of the vehicle using the location tracking module 13 (S110) and transfers voice information for the present location information of the vehicle and the destination information to the server 20 (S112).

Next, the voice recognition module 23 of the server 20 voice-recognizes the voice information (S114) and the path searching module 24 of the server 20 generates route guidance information for the present location of the vehicle and the destination location based on the electronic map stored in the electronic map database (S116) and transfers the generated route information for the present location and the destination location to the travelling route guidance system 10 (S118).

In response to receiving the route guidance information from the server 20, the control module 16 of the route guidance system 10 transfers the route guidance information to the car-audio apparatus 30 (S120). The data processing module 34 of the car-audio apparatus 30 receives the route guidance information between the present location of the vehicle and the destination location while in the route providing mode, processes the route guidance information to compatible with the interface of the car-audio apparatus 30, and sends the processed route information to the display module 35 (S122).

Finally, the display module 35 of the car-audio apparatus 30 displays the processed route guidance information on the display of the car-audio apparatus.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A travelling route guidance system using a car-audio apparatus, the system comprising:
an input module which receives destination information to be visited by a driver from the driver through a voice;
a location tracking module which grasps present location information of a vehicle; and
a control module which transfers the present location information of the vehicle and voice information for the destination information to a server, and receives travelling route information between the present location information of the vehicle and the destinations information, which is searched through an electronic map of the server, from the server,
wherein the control module transfers the travelling route information to the car-audio apparatus and allows the car-audio apparatus to display the travelling route information through an interface of a display module of the car-audio apparatus.

2. The system according to claim 1, wherein the travelling route information includes one or more of a group consisting of a left-turn guidance at a specific intersection, a right-turn guidance at the specific intersection, a straight guidance, a straight distance guidance, road information and destination arrival information,
wherein the left-turn guidance at the specific intersection, the right-turn guidance at the specific intersection and the straight distance guidance are displayed via a rewinding interface, a forward winding interface and a reproducing interface of the display module of the car-audio apparatus, respectively and the travelling road information and the destination arrival information are displayed through a reproducing music information interface or a radio channel information display interface of the display module of the car-audio apparatus, respectively.

3. The system according to claim 1, wherein input module receives the destination information to be visited by the driver from the driver via the voice in response to the driver pressing a start button on the car-audio apparatus.

4. The system according to claim 1, wherein the control module further includes a data processing module which transfers interface information of a display module of the car-audio apparatus from the car-audio apparatus, processes the travelling route information between the present location information of the vehicle and the destination information to be suitable to the interface of the car-audio apparatus using the interface information, and transfers the processed information to the car-audio apparatus.

5. A car-audio apparatus for a travelling route guidance system, the apparatus comprising:
a start button which receives a starting signal for starting to request a travelling route between a present location of a vehicle and a destination from a driver and transfers the starting signal to a travelling route guidance system;
a mode change module which changes a mode of the car-audio apparatus from an audio reproducing mode or a radio reproducing mode to a route providing mode according to the starting signal;
a data processing module which receives route guidance information, which is searched through an electronic map by a server, between present position information of the vehicle and the destination which are input by a driver via a voice from the travelling route guidance system while in the route providing mode, and processes the route guidance information to be suitable to an interface of the car-audio apparatus; and
a display module which displays the travelling route information processed to be suitable to the interface of the car-audio apparatus using the interface of the car-audio apparatus.

6. The apparatus according to claim 5, wherein the travelling route information includes one or more of a group consisting of a left-turn guidance at a specific intersection, a right-turn guidance at the specific intersection, a straight guidance, a straight distance guidance, travelling road information and destination arrival information,
the display module displaying the left-turn guidance at the specific intersection, the right-turn guidance at the specific intersection and the straight distance guidance using a rewinding display interface, a forward winding display interface, and a reproducing display interface of the display module of the car-audio apparatus, respectively and display the travelling road information, the straight distance guidance, and the destination arrival information using a reproducing music information interface or a radio channel information display interface of the display module of the car-audio apparatus.

7. A method of guiding a travelling route using a car-audio apparatus, the method comprising:
(a) receiving destination information to be visited by a driver through a voice from the driver;
(b) determining present location information of a vehicle;
(c) transferring the present location information of the vehicle and voice information for the destination information to a server;
(d) receiving travelling route information between the present location information of the vehicle and the destination information, which is searched through an electronic map of the server, from the server; and
(e) transferring the travelling route information to the car-audio apparatus and allowing the car-audio apparatus to display the travelling information through an interface of a display module thereof.

8. The method according to claim 7, wherein the travelling route information includes one or more of a group consisting of a left-turn guidance at a specific intersection, a right-turn guidance at the specific intersection, straight guidance, a straight distance guidance, road information and destination arrival information,
wherein the left-turn guidance at a specific intersection, the right-turn guidance at the specific intersection and the straight distance guidance are displayed via a rewinding display interface, a forward winding display interface, and a reproducing display interface of the display module of the car-audio apparatus, respectively and displaying the road information, the straight distance guidance, and the destination arrival information are displayed through a reproducing music information interface or a radio channel information display interface of the display module of the car-audio apparatus, respectively.

9. The method according to claim 7, further comprising pressing a button of the car-audio apparatus by the user before receiving the destination information to be visited by the driver.

10. A method of guiding a travelling route using a car-audio apparatus, the method comprising:
(a) receiving a starting signal for starting to request a travelling route between a present location of a vehicle and a destination from a driver and transferring the starting signal to a travelling route guidance system;
(b) changing a mode of the car-audio apparatus from an audio reproducing mode or a radio reproducing mode into a route providing mode;
(c) receiving travelling route information, which is searched through an electronic map by a server, between present position information of the vehicle and the destination which are input by a driver via a voice from the travelling route guidance system while in a route providing mode,
(d) processing the route guidance information to be suitable to an interface of the car-audio apparatus; and
(e) displaying the route guidance information processed to be suitable to the interface of the car-audio apparatus using the interface of the car-audio apparatus.

11. The method according to claim 10, wherein the route guidance information includes one or more selected from a group consisting of a left-turn guidance at a specific intersection, a right-turn guidance at the specific intersection, straight guidance, a straight distance guidance, travelling road information and destination arrival information,
wherein the left-turn guidance at the specific intersection, the right-turn guidance at the specific intersection and the straight distance guidance are displayed using a rewinding interface, a forward winding interface, and a reproducing interface of the display module of the car-audio apparatus, respectively and the road information, the straight distance guidance, and the destination arrival information are displayed using a reproducing music information interface or a radio channel information display interface of the display module of the car-audio apparatus, respectively.

12. A route guidance system utilizing a car-audio apparatus, the system comprising:
an first module configured to receive a destination location from the driver;
a second module configured to determine a present location of a vehicle; and
a third module configured to
transfer present location information of the vehicle and voice information for the destination location to a server, and
receive route guidance information, from the server,
wherein the route guidance information is searched via an electronic map on the server, and
wherein the control module transfers the route guidance information to the car-audio apparatus and allows the car-audio apparatus to display the route guidance information via an interface of a display module of the car-audio apparatus.
